(19) United States
(12) Patent Application Publication
(10) Pub. No.: US 2005/0080597 A1
(43) Pub. Date: Apr. 14, 2005

(54) System and method for monitoring equipment

(76) Inventors: Timothy P. Blair, Boise, ID (US); Roger T. Baird, Boise, ID (US); Burton H. Poppenga, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/683,913

(22) Filed: Oct. 10, 2003

(51) Int. Cl. G06F 15/00

(52) U.S. Cl. 702/188

(57) ABSTRACT

A system and method for monitoring equipment. The system (100) includes a novel monitoring appliance (102) comprising one or more data ports (106) for receiving data from the equipment, a communication module (118) for receiving a set of configuration data (116), and a mechanism (112) for processing the equipment data in accordance with a plurality of optional services, wherein the configuration data (116) is adapted to enable or disable the optional services. The mechanism is comprised of software (112) for processing the equipment data, the software (112) including one or more software components (114), each software component (114) for performing an optional service, a memory (110) for storing the software (112), and a processor (108) for executing the software (112) in accordance with the configuration data (116), which is adapted to enable or disable the software components (114). The monitoring system (100) also includes a central server (104) adapted to transmit the configuration data (116) to the monitoring appliance (102).

### BACKGROUND OF THE INVENTION

1. Field of the Invention

The present invention relates to systems for monitoring equipment. More specifically, the present invention relates to systems and methods for remotely retasking monitoring appliances.

2. Description of the Related Art

In the office equipment industry, different customers have different requirements as to their business relationship with the manufacturer of the equipment or other service provider. Some customers may wish to own their equipment, such as printers, copiers, and fax machines, while others may wish to lease the equipment and be billed based on usage, i.e. a “pay per use” basis. In order to bill the customer for usage, the leasing company needs to be able to collect data on the usage of the equipment, for instance, the number of pages that were printed by a printer during a predetermined time period.

There are two ways to collect this data: manually or automated. In the manual approach, someone must travel to the customer site periodically to collect usage counts. This approach can be very time consuming and expensive. The alternative is to use an automated monitoring appliance, located at the customer site, which collects data from the leased equipment and transmits the data to a central server located at the leasing company.

Prior art monitoring appliances were originally designed to provide a single service, i.e. to collect usage data from a particular device. Now there is a desire to make these monitoring appliances more versatile, capable of providing additional functions beyond collecting usage counts for billing. For instance, the leasing company may want to collect data related to service information to help determine when repairs or preventive maintenance is needed.

Furthermore, there is a desire to remotely control which function a monitoring appliance is performing at any given time. Then, if a monitoring appliance breaks or is overloaded, a second appliance at the same customer site can be remotely reconfigured to take over the tasks of the first appliance. With prior art monitoring appliances, if an appliance needs to be retasked (changed to perform a different function), someone must travel to the customer site to reconfigure the appliance. There is no way to remotely retask the appliance.

Hence, a need exists in the art for a system or method for remotely retasking monitoring appliances.

### SUMMARY OF THE INVENTION

The need in the art is addressed by the system and method for monitoring equipment of the present invention. The system includes a novel monitoring appliance comprising one or more data ports for receiving data from the equipment, a communication module for receiving a set of configuration data, and a mechanism for processing the equipment data in accordance with a plurality of optional services, wherein the configuration data is adapted to enable or disable the optional services. The mechanism is comprised of software for processing the equipment data, the software including one or more software components, each software component for performing an optional service, a memory for storing the software, and a processor for executing the software in accordance with the configuration data, which is adapted to enable or disable the software components. The monitoring system also includes a central server adapted to transmit the configuration data to the monitoring appliance.

### BRIEF DESCRIPTION OF THE DRAWINGS

FIG. 1 is a diagram of an illustrative system for monitoring equipment.

FIG. 2 is a block diagram of a prior art monitoring appliance.

FIG. 3 is a flow chart of the prior art retasking process.

FIG. 4 is a flow chart of the prior art software upgrading process.

FIG. 5 is a block diagram of a system for monitoring equipment designed in accordance with an illustrative embodiment of the present invention.

FIG. 6 is a flow chart of a method for retasking monitoring appliances in accordance with an illustrative embodiment of the present invention.

FIG. 7 is a flow chart of a method for retasking and/or upgrading monitoring appliances in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Although the illustrative embodiments of the invention described are adapted for monitoring printers, the invention can be adapted to monitor other types of equipment such as copiers, facsimile machines, scanners, and the like without departing from the scope of the present teachings.

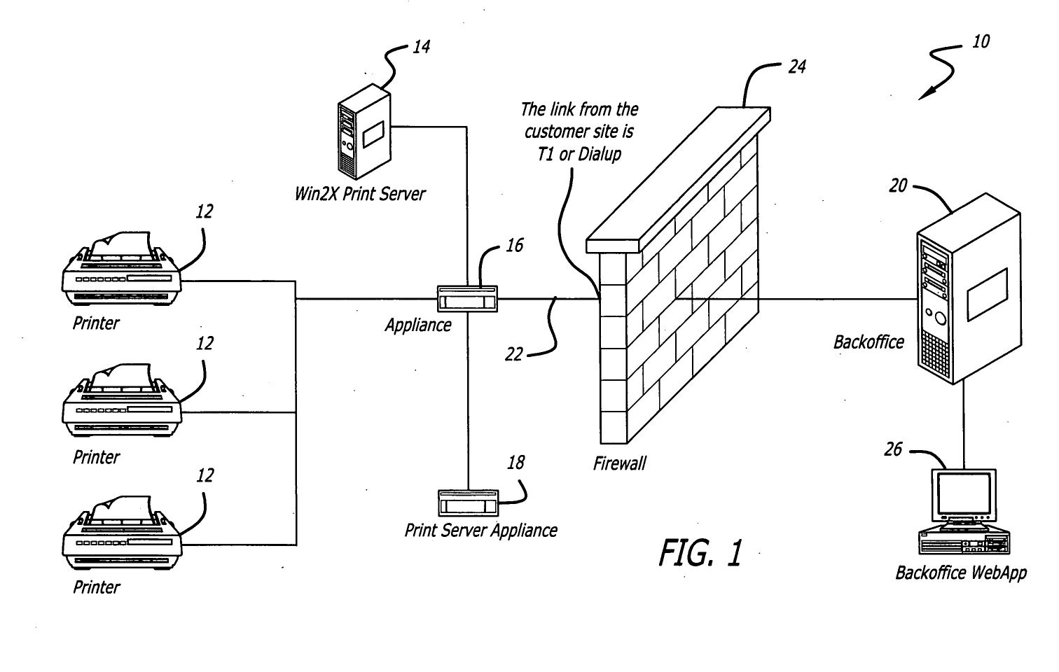

FIG. 1 is a diagram of an illustrative system 10 for monitoring equipment. A plurality of devices (three printers 12 and a print server 14 in the example) at a customer site are monitored by one or more monitoring appliances (two appliances 16 and 18 are shown in FIG. 1). One appliance 16 is configured to collect data from the printers 12 and the other appliance 18 is configured to collect data from the print server 14. The monitoring appliances 16 and 18 transmit the collected data to a central server 20 located at the backoffice (i.e. the leasing company) via some communication channel 22. Any communication link 22 can be used, such as dial-up, internet, or wireless, and the link 22 may have to pass network firewalls 24 at the customer and/or the backoffice. In the example, the central server 20 is maintained through a web application 26.

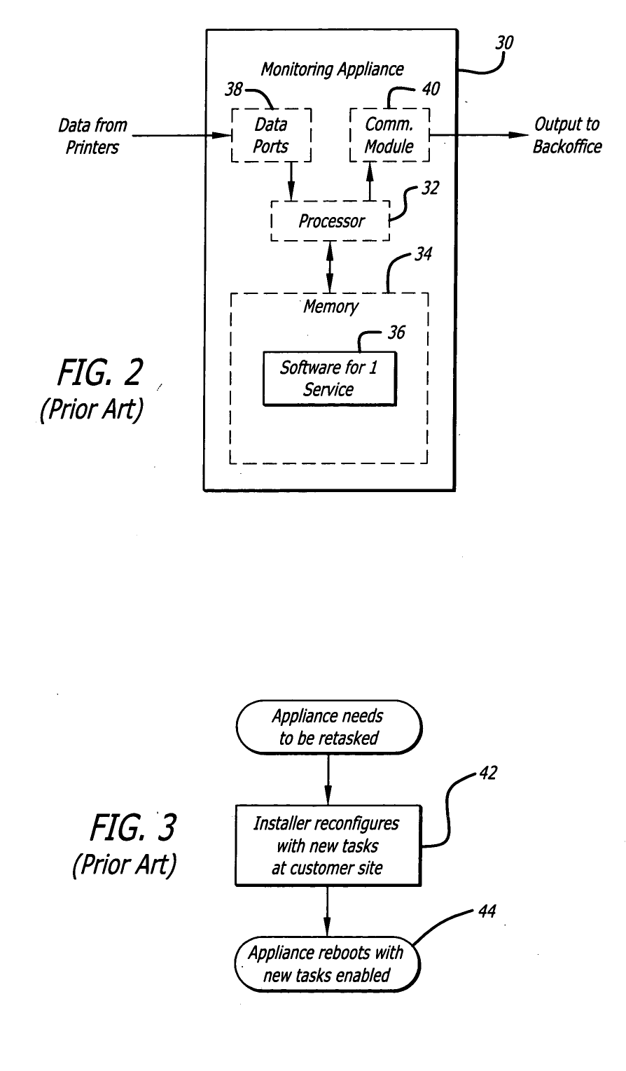

FIG. 2 is a block diagram of a prior art monitoring appliance 30. The monitoring appliance 30 includes a processor 32 and memory 34, running software 36 for a particular service. Data from the devices being monitored is input through a data port 38, processed by the software 36, and transmitted to the backoffice by a communication module 40. As discussed above, prior art monitoring appliances are limited to providing a single service. (Each service may require multiple tasks.) In the example of FIG. 1, if the printer monitoring appliance 16 breaks or is overloaded, the print server monitoring appliance 18 cannot be remotely retasked to perform the printer monitoring appliance's functions. FIG. 3 is a flow chart of the prior art retasking process. In order to retask an appliance, an installer must travel to the customer site and manually reconfigure the appliance (Step 42). The appliance can then reboot with the new tasks enabled (Step 44).

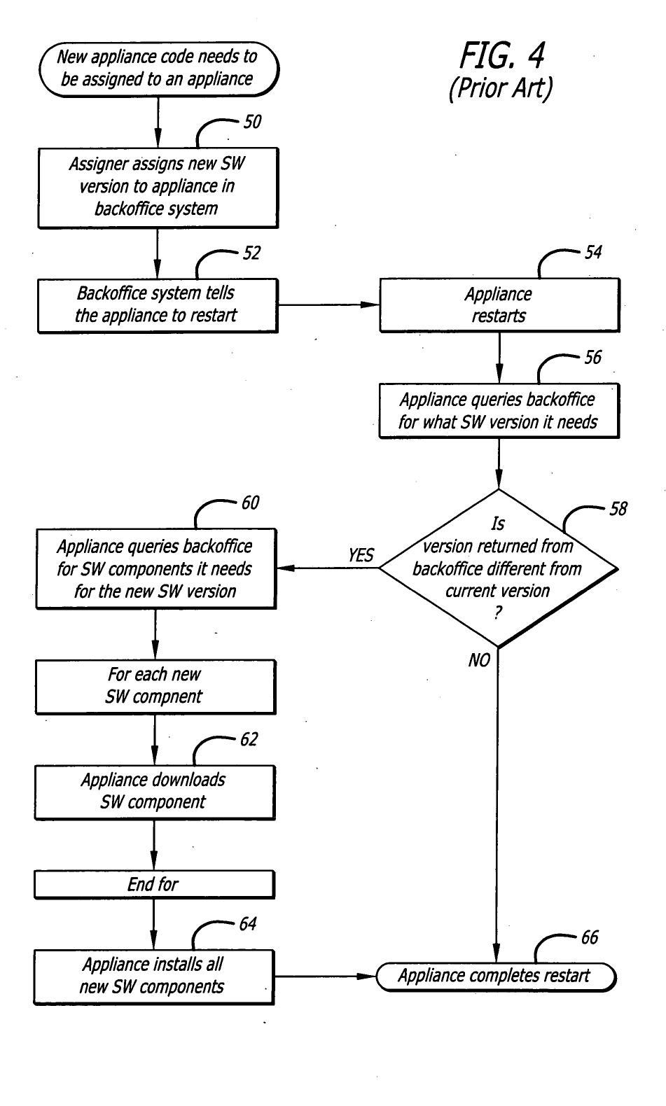

Prior art monitoring appliances were designed with the ability to upgrade their software remotely from the backoffice. FIG. 4 is a flow chart of the prior art software upgrading process. When new appliance code needs to be assigned to an appliance, the new software version is assigned to the appliance in the backoffice system (Step 50) and the backoffice system instructs the appliance to restart (Step 52). The appliance restarts (Step 54) and queries the backoffice for what software version it should have (Step 56). If the version returned from the backoffice is the same as the version the appliance has (Step 58), then the appliance completes its restart process (Step 66). If the returned version is different from the version the appliance has, then the appliance queries the backoffice for the software components it needs for the new software version (Step 60). For each new software component, the appliance downloads the component from the backoffice server (Step 62). The appliance installs all the new software components (Step 64) and completes its restart process (Step 66).

Using the prior art software upgrading system, software for new functions could be uploaded to a monitoring appliance, but there was no way to remotely instruct the appliance to execute the new functions in the new software, i.e. retasking.

The monitoring system of the present invention allows for remote retasking of monitoring appliances by separating configuration information that includes which functions should be enabled or disabled, from the appliance software. In prior art appliances, the configuration information was embedded in the software. This meant that a monitoring appliance would have to be remanufactured to be retasked.

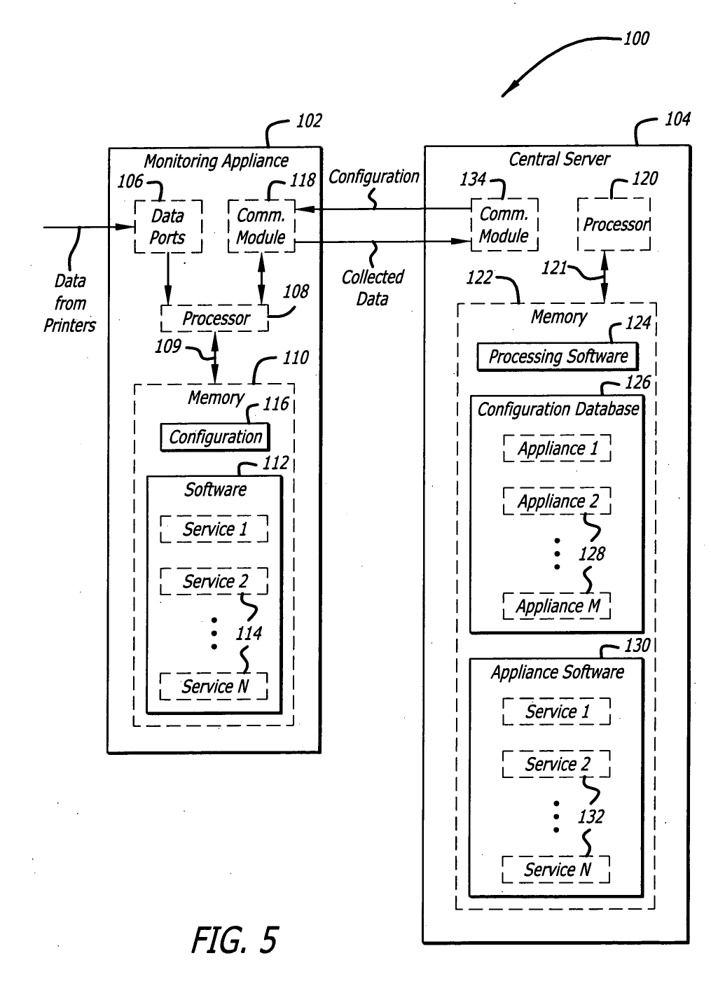

FIG. 5 is a block diagram of a system 100 for monitoring equipment designed in accordance with an illustrative embodiment of the present invention. The system 100 includes one or more monitoring appliances 102 located at one or more customer sites and a central server 104 located at the backoffice. Each monitoring appliance 102 is adapted to collect data from one or more printers (or other types of equipment to be monitored) via one or more data ports 106. The monitoring appliance 102 may also be adapted to transmit data or instructions to the printers. In the illustrative embodiment, the monitoring appliance 102 is a stand-alone device, separate from the equipment it is monitoring; however, the invention is not limited thereto. The monitoring appliance 102 may be disposed within the housing of a device to be monitored (i.e.—within a printer) without departing from the scope of the present teachings.

The novel monitoring appliance 102 includes one or more data ports 106 for receiving data from the equipment; a communication module 118 for receiving a set of configuration data 116; software 112 for processing the equipment data, the software 112 including one or more software components 114, each software component 114 for performing an optional service; a memory 110 for storing the software 112; and a processor 108 for executing the software 112 in accordance with the configuration data 116.

In accordance with the teachings of the present invention, the software 112 includes one or more configurable software components 114, each software component 114 for performing a different service of the monitoring appliance 102. The software components 114 are enabled for or disabled from execution in accordance with the configuration data 116. In one embodiment of the invention, all monitoring appliances get the same software 112, which includes the software components 114 for all the different functions that can be performed by the appliance 102.

The monitoring appliance 102 is equipped with a communication module 118 adapted to receive the configuration data 116 from the central server 104. The configuration data 116 is separate from the appliance software 112 and tells the appliance 102 which functions to perform, i.e. which software components 114 are enabled for or disabled from execution. The configuration data 116 may also include other information such as what network ports are enabled. The communication module 118 may also be adapted to receive new or upgraded software components, which can also be enabled for or disabled from execution by the configuration data 116. The communication module 118 is also used to transmit data collected from the equipment to the central server 104.

The central server 104 includes a processor 120, a memory 122 coupled to the processor 120 by a bus 121, and a communication module 134. The central server 104 is running software 124 for controlling and processing data to and from the monitoring appliance 102. Stored in the memory 122 of the central server 104 is a database 126 of the configurations 128 for all the monitoring appliances 102. The communication module 134 is adapted to transmit the configuration data 128 to the monitoring appliances 102. The central server 104 may also include a database 130 of all the appliance software components 132. The communication module 134 may also be adapted to transmit new or upgraded software components to the monitoring appliances 102. In the illustrative embodiment, the link between the communication modules 118 and 134 is a dial-up or internet connection. However, the invention is not limited thereto. Other types of communication links, such as wireless, may be used without departing from the scope of the present teachings.

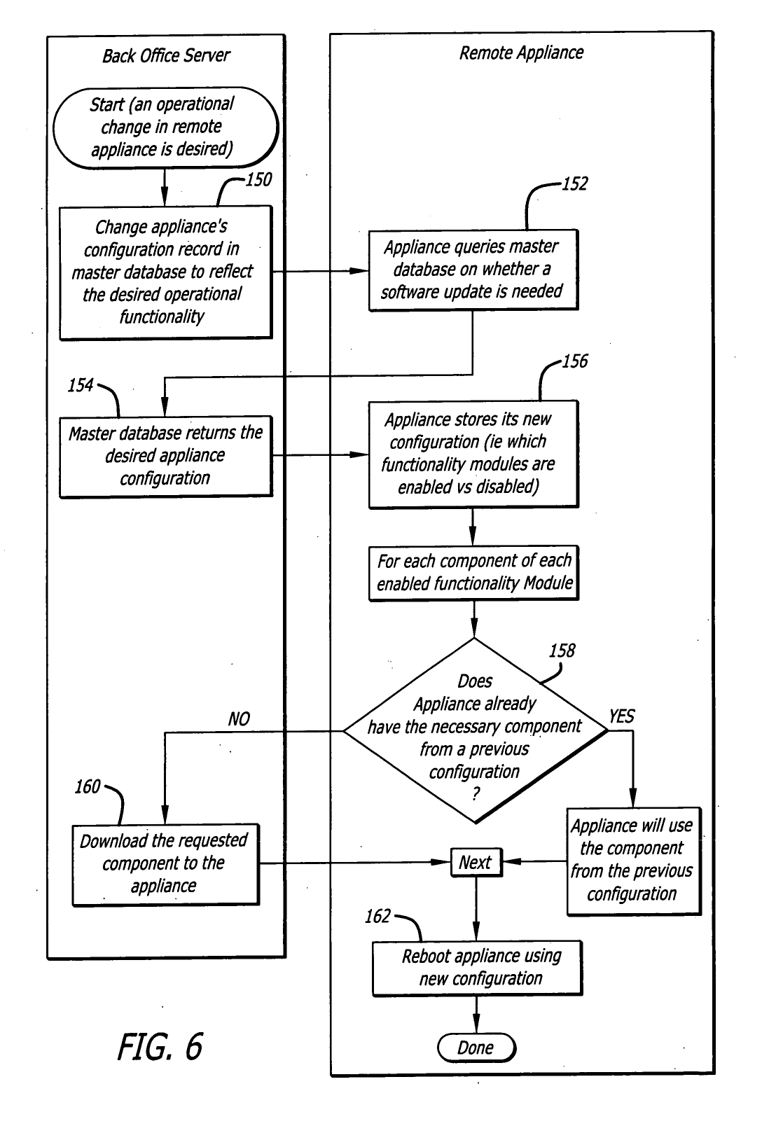

FIG. 6 is a flow chart of a method for retasking monitoring appliances in accordance with an illustrative embodiment of the present invention. When a monitoring appliance 102 needs to be configured for a task, or to reconfigure it to perform a different task, first the appliance's configuration record 128 in the master database 126 of the backoffice server 104 is changed to reflect the desired operational functionality (Step 150), i.e., which software components 114 are to be enabled or disabled. In an illustrative embodiment, a user can change the configuration record 128 of an appliance using a web page hosted at the backoffice server 104. Other applications adapted for modifying the configuration records may be used without departing from the scope of the present teachings. For instance, a Win32, Linux, or Shell script application may be used.

The remote appliance 102 connects to the backoffice server 104, identifies itself (which appliance it is), and queries whether an update is needed (Step 152). The backoffice 104 sends the new configuration data 128 to the appliance 102 (Step 154). The appliance 102 then stores the received data as its new configuration 116 (Step 156).

With a monitoring system designed in accordance with the present teachings, the monitoring appliance 102 can be remotely instructed to perform new functions. As new software components with new capabilities are developed, they can be uploaded to the appliance, and the configuration data can be changed to instruct the appliance to use the new software components. The appliance does not need to know about the new functions in advance.

In one embodiment of the present invention, the monitoring appliance 102 is manufactured having only bootstrap code. When the appliance 102 first powers up, it loads its software and configuration from the backoffice with the most current versions. If the appliance 102 has any problems, it drops back to the bootstrap, which causes a fresh update of software and configuration.

In accordance with the illustrative embodiment shown in FIG. 6, after an appliance 102 has received its new configuration data 116 (Step 156), for each software component of each enabled functionality module, the appliance 102 determines whether it already has the necessary component (Step 158). If yes, then the appliance 102 does not need any additional software and reboots using its new configuration (Step 162). If no, then the appliance 102 downloads the needed software components from the backoffice server 104 (Step 160). After all the new software components are downloaded, the appliance reboots using its new configuration (Step 162).

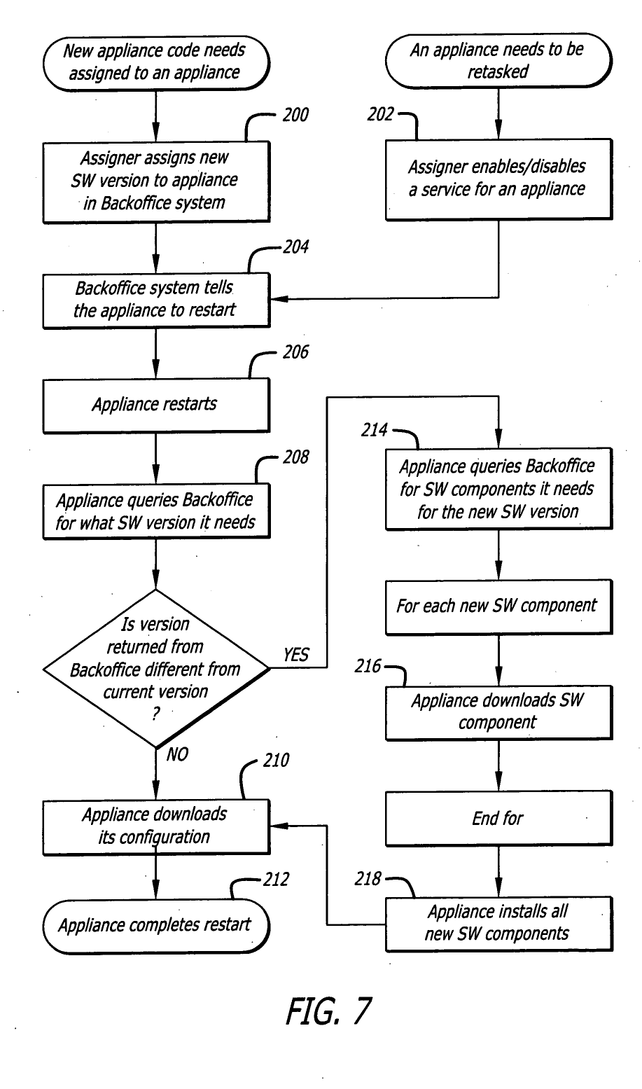

FIG. 7 is a flow chart of a method for retasking and/or upgrading monitoring appliances in accordance with an illustrative embodiment of the present invention. In this embodiment, each monitoring appliance 102 is updated with all new software components, whether or not its configuration requires it. When new appliance code needs to be assigned to an appliance 102, the new software version is assigned to the appliance in the backoffice server 104 (Step 200). When an appliance 102 needs to be retasked, the configuration record 128 for that appliance in the master database 126 of the backoffice server 104 is changed to reflect the desired operational functionality (Step 202).

Upon either event, the backoffice server 104 instructs the appliance 102 to restart (Step 204) and the appliance 102 restarts (Step 206). During the restart process, the appliance 102 queries the backoffice 104 for what software version it needs (Step 208).

If the version returned from the backoffice is the same as the one the appliance is currently running, then the appliance 102 doesn't need a software upgrade. It downloads its configuration 128 from the backoffice 104 (Step 210) and completes its restart process (Step 212).

If the version returned from the backoffice is different from the one the appliance is currently running, then the appliance 102 queries the backoffice 104 for which software components it needs for the new software version (Step 214). The appliance 102 then downloads each new component (Step 216), and installs them (Step 218). The appliance 102 downloads its configuration 182 from the backoffice 104 (Step 210) and completes its restart process (Step 212).

For a simple retasking that does not require a software update, only the configuration information is transmitted to the appliance. The configuration data is small, typically less than one network packet. A monitoring appliance can therefore be very quickly retasked.

The ability to do retasking without travel to the customer site allows the management of the appliances to be extremely flexible. For example, if several appliances are installed at a customer site, each appliance tasked to manage different services, one of these appliances can be remotely retasked to help with or take over the load when another appliance is overloaded with its service or broken. Additionally, “hot” spare appliances can be installed that are powered on and for which the software is kept up to date, which can be retasked to handle current services for an overloaded or broken appliance. These “hot” spare appliances could also be used to implement new services without having to send personnel to the customer's site.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

1. An appliance for monitoring equipment comprising:
first means for receiving data from said equipment;
second means for receiving a set of configuration data; and
third means for processing said equipment data in accordance with a plurality of optional services, wherein said configuration data is adapted to enable or disable said optional services.

2. The invention of claim 1 wherein said third means includes:
software for processing said equipment data, said software including one or more software components, each software component for performing an optional service;
fourth means for storing said software; and
fifth means for executing said software in accordance with said configuration data, which is adapted to enable or disable said software components.

3. The invention of claim 2 wherein said fourth means is a memory.

4. The invention of claim 3 wherein said memory is also adapted to store said configuration data.

5. The invention of claim 2 wherein said fifth means is a processor.

6. The invention of claim 1 wherein said first means includes one or more data ports.

7. The invention of claim 6 wherein said data ports are also adapted to transmit data to said equipment.

8. The invention of claim 1 wherein said second means includes a communication module.

9. The invention of claim 1 wherein said appliance further includes means for transmitting data to a remote system.

10. The invention of claim 2 wherein said appliance further includes means for receiving new or upgraded software components.

11. The invention of claim 10 wherein said configuration data is adapted to enable or disable a new or upgraded software component.

12. The invention of claim 4 wherein said software is adapted to restart said appliance after receiving and storing said configuration data.

13. The invention of claim 8 wherein said appliance is adapted to restart upon receiving a restart signal from said communication module.

14. The invention of claim 13 wherein said appliance is adapted to receive said configuration data from said communication module during a restart process.

15. The invention of claim 13 wherein said appliance is adapted to receive and store new or upgraded software components from said communication module during a restart process.

16. The invention of claim 8 wherein said communication module is coupled to an internet connection.

17. The invention of claim 8 wherein said communication module is coupled to a dial-up connection.

18. The invention of claim 1 wherein said communication module is coupled to a wireless connection.

19. The invention of claim 1 wherein said appliance is a stand-alone device separate from said equipment.

20. The invention of claim 1 wherein said equipment includes one or more printers.

21. An appliance for monitoring equipment comprising:
a data port for receiving data from said equipment;
a communication module for receiving one or more software components, each software component for processing said equipment data in accordance with an optional service, and for receiving a set of configuration data adapted to enable or disable said software components;
a memory for storing said software components; and
a processor for executing said software components in accordance with said configuration data.

22. An appliance for monitoring one or more office equipment devices comprising:
a data port for receiving data from said equipment;
software adapted primarily for monitoring said devices, said software including one or more software components, each software component for processing said equipment data in accordance with an optional service;
a communication module for receiving a set of configuration data adapted to enable or disable said software components;
a memory for storing said software; and
a processor for executing said software in accordance with said configuration data.

23. A system for monitoring equipment comprising:
one or more monitoring appliances adapted to monitor said equipment, each monitoring appliance including:
first means for receiving data from said equipment;
second means for receiving a set of configuration data; and
third means for processing said equipment data in accordance with a plurality of optional services, wherein said configuration data is adapted to enable or disable said optional services; and
fourth means for transmitting said configuration data to said monitoring appliances.

24. The invention of claim 23 wherein said fourth means includes a central server.

25. The invention of claim 24 wherein said central server includes a first database of configuration data for the monitoring appliances.

26. The invention of claim 25 wherein a user can change which services in a monitoring appliance are enabled or disabled by modifying the configuration data for that monitoring appliance stored in said first database.

27. The invention of claim 25 wherein said central server includes an application for modifying the configuration data stored in said first database.

28. The invention of claim 27 wherein said application is a web application.

29. The invention of claim 24 wherein said third means includes:
software for processing said equipment data, said software including one or more software components, each software component for performing an optional service;
a memory for storing said software; and
a processor for executing said software in accordance with said configuration data, which is adapted to enable or disable said software components.

30. The invention of claim 29 wherein said central server includes a second database of new or upgraded software components.

31. The invention of claim 30 wherein said monitoring appliances further include means for receiving new or upgraded software components from said central server.

32. The invention of claim 31 wherein said configuration data is adapted to enable or disable a new or upgraded software component.

33. The invention of claim 29 wherein said software is adapted to restart said monitoring appliance after receiving and storing said configuration data.

34. The invention of claim 29 wherein said software is adapted to restart said monitoring appliance upon receiving a restart signal from said central server.

35. The invention of claim 34 wherein said software is adapted to receive and store said configuration data from said central server during a restart process.

36. The invention of claim 34 wherein said software is adapted to receive and store new or upgraded software components from said central server during a restart process.

37. A system for monitoring office equipment comprising:
one or more monitoring appliances adapted to monitor said office equipment, each monitoring appliance including:
a data port for receiving data from said equipment;
appliance software adapted primarily for monitoring said devices, said software including one or more software components, each software component for processing said equipment data in accordance with an optional service;
a first communication module for receiving a set of configuration data adapted to enable or disable said software components;
a first memory for storing said appliance software; and
a first processor for executing said software in accordance with said configuration data; and
a central server including:
server software for controlling the communication of data to and from said monitoring appliances;
a first database of configuration data for said monitoring appliances;
a second memory for storing said server software and said first database;
a second processor for executing said server software; and
a second communication module for transmitting said configuration data to said monitoring appliances.

38. The invention of claim 37 wherein said central server further includes an application for modifying the configuration data stored in said first database.

39. The invention of claim 37 wherein said central server further includes a second database of new or upgraded software components.

40. The invention of claim 39 wherein said first and second communication means are also adapted to download new or upgraded software components from said central server to said monitoring appliances.

41. The invention of claim 40 wherein said configuration data is adapted to enable or disable a new or upgraded software component.

42. A system for monitoring office equipment comprising:
one or more monitoring appliances adapted to monitor said office equipment, each monitoring appliance including:
a data port for receiving data from said equipment;
a first communication module for receiving one or more software components, each software component for processing said equipment data in accordance with an optional service, and for receiving a set of configuration data adapted to enable or disable said software components;
a first memory for storing said software components; and
a first processor for executing said software components in accordance with said configuration data; and
a central server including:
server software for controlling the communication of data to and from said monitoring appliances;
a first database of configuration data for said monitoring appliances;
a second database of software components for said monitoring appliances;
a second memory for storing said server software and said first and second databases;
a second processor for executing said server software; and
a second communication module for transmitting said configuration data and said software components to said monitoring appliances.

43. A method for remotely configuring a monitoring appliance for monitoring equipment including the steps of:
storing a plurality of configurable software components in said monitoring appliance, each software component for performing a function of said monitoring appliance;
storing, in a central server, configuration data that determines which software components are enabled or disabled;
downloading said configuration data from said central server to said monitoring appliance; and
restarting said monitoring appliance with said software components enabled for or disabled from execution in accordance with said configuration data.

44. The invention of claim 43 wherein a user can change which software components are enabled or disabled by modifying the configuration data stored in the central server.

45. The invention of claim 43 wherein said method further includes the steps of:
storing new or upgraded software components in said central server;
downloading said new or upgraded software components from said central server to said monitoring appliance; and
installing said new or upgraded software components in said appliance.

46. The invention of claim 45 wherein said configuration data is adapted to enable or disable a new or upgraded software component.
